(19) United States
(12) Patent Application Publication
(10) Pub. No.: US 2024/0131463 A1
(43) Pub. Date: Apr. 25, 2024

(54) RESUABLE ADSORPTION CABIN AIR FILTRATION SYSTEM

(71) Applicant: THE REGENTS OF THE UNIVERSITY OF CALIFORNIA, Oakland, CA (US)

(72) Inventors: Heejung Jung, Irvine, CA (US); Jacob Swanson, Bloomington, MN (US)

(73) Assignee: THE REGENTS OF THE UNIVERSITY OF CALIFORNIA, Oakland, CA (US)

(21) Appl. No.: 18/491,245

(22) Filed: Oct. 19, 2023

Related U.S. Application Data
(60) Provisional application No. 63/417,764, filed on Oct. 20, 2022.

(51) Int. Cl. B01D 46/10; B01D 41/00

(52) U.S. Cl. CPC B01D 46/10; B01D 41/00; B01D 2253/102

(57) ABSTRACT

A cabin air filtration system and method for regenerating a cabin air filtration system are disclosed. The filtration system includes a frame, and a renewable sorption layer within the frame, the renewable sorption layer configured to clean air from one or more of outside of an automobile and inside an automobile. The cabin air filtration system for an automobile can include a first layer, the first layer configured to particulates, and a second layer, the second layer configured to remove volatile compounds and gases. The method includes placing a renewable sorption layer within a frame in an oven, the renewable sorption layer configured to filter air from one or more of outside of the automobile and inside the automobile; creating a vacuum within the oven; and heating a source of water within the oven to perform a steam regeneration treatment on the renewable sorption layer.

### CROSS-REFERENCES TO RELATED APPLICATIONS

This application claims priority to U.S. Provisional Patent Application No. 63/417,764 filed on Oct. 20, 2022, the entire content of which is incorporated herein by reference.

### TECHNICAL FIELD

The present disclosure generally relates to a reusable adsorption cabin air filtration system, and method for regeneration of the reusable adsorption cabin air filtration system.

### BACKGROUND

Cabin air filters generally aim to reduce the penetration of air pollutants including particulate matter and gas phase materials. However, the amount of charcoal in the charcoal sprayed cabin filter is generally not enough to make any significant reduction of VOC (volatile organic compounds) penetrating into and generated from vehicle cabin for a long time. As such, frequent replacement is necessary to have a functional adsorption type cabin filter to reduce VOCs in cabin. The objective of the current disclosure is to have longevity of adsorption capacity for the cabin filter so that a reasonable maintenance interval can be expected, for example, every 10,000 miles to 20,000 miles driven or annual or biannual replacement.

### SUMMARY

It would be desirable to reduce in-vehicle concentration of VOCs, reactive gases (such as ozone and NO₂) and hydrocarbon gases (called VOCs, volatile organic compounds) using adsorbent such as activated carbon in a packed bed housing, and wherein the filter can be made as an aftermarket product using the same housing geometry of the existing cabin filter system or a new design can be made for a new car cabin system working with auto manufacturer.

In accordance with an embodiment, a cabin air filtration system comprising: a frame; and a renewable sorption layer within the frame, the renewable sorption layer configured to clean air from one or more of air pollutants from outside of an automobile and inside the automobile. The packed bed can help ensure maximum amount of adsorbent in a given volume. In addition, to lower the cost of the user, these adsorbents are renewable as disclosed herein.

In accordance with an embodiment, a cabin air filtration system for an automobile, the cabin air filtration system comprising: a first layer, the first layer configured to remove particulates; and a second layer, the second layer configured to remove volatile compounds and gases.

In accordance with an embodiment, a method for regenerating a cabin air filtration system, the method comprising: placing a renewable sorption layer within a frame in an oven, the renewable sorption layer configured to filter air from one or more of outside of the automobile and inside the automobile; creating a vacuum within the oven; and heating a source of water within the oven to perform a steam regeneration treatment on the renewable sorption layer.

### BRIEF DESCRIPTION OF THE DRAWINGS

FIG. 1 is an illustration of a known fabric cabin for automobiles.

FIG. 2 is an illustration of an embodiment of a reusable adsorption cabin air filtration system in accordance with an embodiment.

FIG. 3 is an illustration of a method for regeneration of the reusable adsorption cabin air filtration system in accordance with an embodiment.

### DETAILED DESCRIPTION

Set forth below with reference to the accompanying drawings is a detailed description of embodiments of a reusable adsorption cabin air filtration system, and method for regeneration of the reusable adsorption cabin air filtration system. Note that since embodiments described below are preferred specific examples of the present disclosure, although various technically preferable limitations are given, the scope of the present disclosure is not limited to the embodiments unless otherwise specified in the following descriptions.

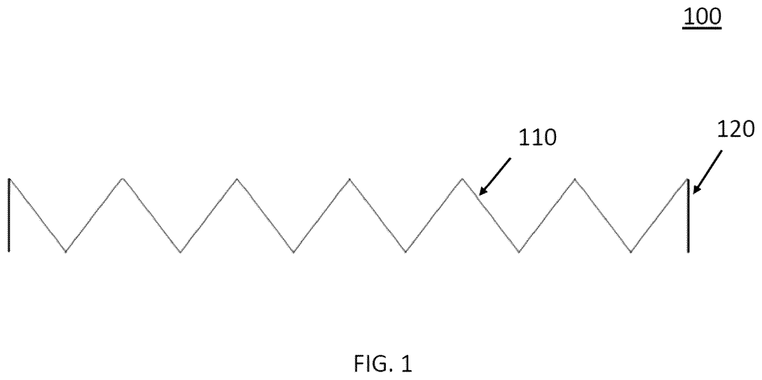

FIG. 1 is an illustration of a known fabric cabin filter 100 for automobiles. As shown in FIG. 1, the fabric filter 100 includes a fabric filter 110 within a plastic or fiber frame 120.

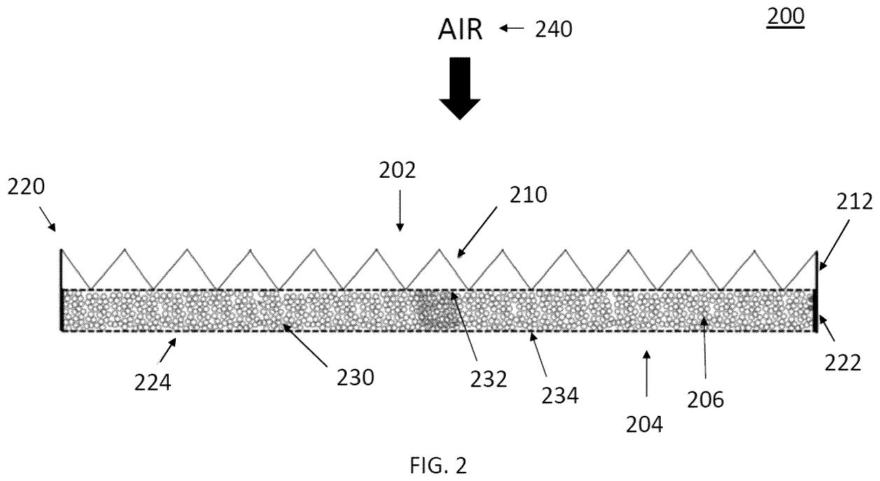

FIG. 2 is an illustration of a reusable adsorption cabin air filtration system 200 in accordance with an embodiment. In an embodiment, the reusable adsorption cabin air filtration system 200 can include a first layer 202 and a second layer 204 housed with a frame 220. The first layer 202 can be a filter layer, for example, a fabric filter, which removes particulates. The second layer 204 can be a sorption layer 206 where volatile organic compounds (VOCs) and gases can be removed. In accordance with an embodiment, an activated carbon or any other adsorbents, which are renewable can be used in the sorption layer 206. The second layer 204 can include a housing 222 and metal mesh 224. Inside the housing 222 and the metal mesh 224 can be a packed activated carbon 230.

In accordance with an embodiment, the ability of adsorbent 206 to reduce VOCs and gasses is not infinite (i.e., the performance the adsorbent 206, for example, the packed activated carbon 230 will decrease over time). Accordingly, once the surfaces of the absorbent 206 are saturated with adsorbed gases and VOCs, the surfaces of the adsorbent 206 should be regenerated as disclosed herein.

In accordance with an embodiment, the frame 220 of the filtration system 200 and the frame 222 of the sorption layer 206 can be made of heat resistant material, for example, a metal, such that the regeneration of sorption filter can be performed in a number of ways. However, the frame 220 of the filtration system can include a separate plastic or fiber frame 212 that houses the first layer 202, and the metal frame 222 for the second layer. In accordance with an embodiment, at least the housing 222 and the metal mesh 224 of the second layer 204 is made from a material, such as a metal, which can be subject to heating (i.e., a relatively high temperature without melting during a regeneration process). The first layer 202, for example, can be replaceable separately while the second layer 205 including the sorption layer 206 can be regenerated following the method disclosed herein.

As shown in FIG. 2, the filtration system 200 is configured to receive a source of outside air 240 that can flow from the first layer (i.e., top layer) 202 to the second layer (i.e., bottom layer) 204. The reusable adsorption cabin air filtration system 200 may have the same surface area at half of the thickness compared to known filters. In addition, as set forth above, the second layer 204 of the reusable adsorption cabin air filtration system 200 can include a packed-bed 230 filled with activated carbon or another renewable adsorbent 206. The top and bottom of the packed bed is supported by the metal mesh 224, which can let air 240 flow through the filter system 200 without the activated carbon being removed from the filter system 200. The fabric filter 210 portion of the reusable adsorption cabin air filtration system 200 can be replaceable and detachable such that the fabric filter is likely a non-renewable and a consumable component of the filtration system 200. However, the fabric filter 210 could be reusable. As set forth above, the rest of the filter system 200 after removing the fabric filter 210 can include the metal frame 222 and activated carbon 230 which can tolerate heat and relatively high temperatures, which are needed for regeneration. In addition, the regeneration of the sorption layer 206 (activated carbon 230 in the packed bed) can be performed. Gases and VOCs eventually saturate the surfaces 232, 234 of the activated carbon 230 and the surfaces 232, 234 need to be regenerated, for example, on a regular basis.

In accordance with an embodiment, the second layer 204 can be a regenerable cartridge containing activated carbon media that can be integrally attached to the first layer 202 (i.e., filtration media). The combined device can be configured such that it is a drop-in replacement that fits in a standard cabin air filter housing (which is typically located behind the glovebox). At a standard interval, the cartridge is separated from the filtration media. The cartridge is regenerated, and the filtration media is disposed. The cartridge is connected to a new piece of filter media and replaced into the vehicle.

In accordance with an embodiment, the activated carbon sorption 230 can be regenerable, in which case the activated carbon must be removable from the housing 220 or the housing 220 must be constructed from a high temperature resistant material. The activated carbon sorption can be disposable. The second layer 204 (i.e., activated carbon sorption unit) can be integrally connected to the first layer 202 (i.e., filtration media) or the second layer 204 and the first layer 202 can be separate components that are not integral or connected to one another. The second layer 204 (i.e., activated carbon sorption unit) can consist of activated carbon felt, granules, or particles. The activated carbon can be in any form. The filtration system 200 can be larger than standard cabin air filter housing, in which case, the standard cabin air filter housing can be replaced with a larger housing to fit the device in an aftermarket approach, or the car OEM can include a larger cabin air filter housing in new vehicles in anticipation of this invention.

In accordance with an embodiment, the air filtration system 200 is configured such the second layer 204 (i.e., sorption layer) of the filtration system 200 is renewable by regeneration method (i.e., desorption method).

In accordance with an embodiment, the filtration system 200 can be configured to remove both gas phase pollutants (e.g., NO₂, O₃ and VOCs) and particulates. For example, in known filters, only a light coating (or sprinkle) of activated carbon is applied to filtration media, which coating typically does not have sufficient capacity to reduce VOCs and NOx over the lifetime of the filtration media. In the filtration system 200 as disclosed herein, the second layer 204 having the separate activated carbon sorption layer 230 can increase the effective lifetime of the filtration system 200.

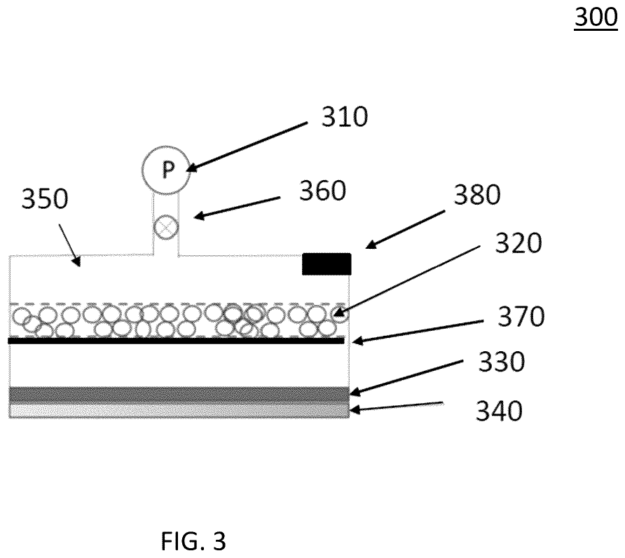

The regeneration of the second layer 204 can be performed in one or more processes. However, it is desirable that the regeneration be performed in a relatively cost effective way. For example, the regeneration of the second layer 204 can be performed by placing second layer 204 with the sorption filter 230 in a ventilated oven 300 as shown in FIG. 3. In accordance with an embodiment, a tray filled with water can place underneath the second layer 204 and the packed bed of activated carbon 230 in the ventilated oven 300.

As shown in FIG. 3, the steam regeneration method can include placing the packed bed filter 320 in a chamber 350 filled with distilled water 330. A pump 310, for example, a manual pump or manual plunger can be used to place the chamber 350 in a vacuum condition. A heater 340, for example, an electric heater 340 can be used to generate steam from the distilled water 330 in the chamber 350 and provides a steam regeneration condition for the packed bed filter 320. For example, the packed filter bed 320 can be placed in the ventilated oven 300 on a mesh tray (or mesh pan) 370 over the distilled water 330. In accordance with an embodiment, the contaminants in the packed filter bed 320 can be removed from the ventilated oven 300 by a fan 380. As described, the steam regeneration method can be a relatively simple and inexpensive system that can be, for example, a home unit.

The detailed description above describes embodiments of a reusable adsorption cabin air filtration system and method for regeneration of the reusable adsorption cabin air filtration system. The invention is not limited, however, to the precise embodiments and variations described. Various changes, modifications and equivalents may occur to one skilled in the art without departing from the spirit and scope of the invention as defined in the accompanying claims. It is expressly intended that all such changes, modifications and equivalents which fall within the scope of the claims are embraced by the claims.

What is claimed is:

1. A cabin air filtration system comprising:
a frame; and
a renewable sorption layer within the frame, the renewable sorption layer configured to clean air from one or more of air pollutants from outside of an automobile and inside the automobile.

2. The cabin air filtration system of claim 1, wherein the frame includes a metal housing with a mesh arrangement connected to the metal housing.

3. The cabin air filtration system of claim 1, wherein the renewable sorption layer is an activated carbon.

4. The cabin air filtration system of claim 3, wherein the activated carbon is regenerable.

5. The cabin air filtration system of claim 3, wherein the activated carbon is selected from one or more of a carbon felt, carbon granules, and/or carbon particles.

6. The cabin air filtration system of claim 1, further comprising:
a fabric filter, the fabric filter arranged on an upper surface of the cabin air filtration system, the upper surface configured to face outward within a cabin air intake of the automobile.

7. The cabin air filtration system of claim 6, wherein the fabric filter is replaceable and detachable from the frame of the cabin air filtration system.

8. The cabin air filtration system of claim 1, wherein the frame and the renewable sorption layer is configured to tolerate heat during a regeneration process.

9. The cabin air filtration system of claim 1, wherein the sorption layer is configured to filter gases and hydrocarbon gases and/or volatile organic compounds.

10. The cabin air filtration system of claim 1, wherein the cabin air filtration system is sized to fit within an existing cabin air filter.

11. A cabin air filtration system for an automobile, the cabin air filtration system comprising:
a first layer, the first layer configured to particulates; and
a second layer, the second layer configured to remove volatile compounds and gases.

12. The cabin air filtration system of claim 11, wherein the first layer includes a fabric filter.

13. The cabin air filtration system of claim 11, wherein the second layer is a renewable sorption layer within a frame, the frame including a metal housing with a mesh arrangement connected to the metal housing.

14. The cabin air filtration system of claim 13, wherein the renewable sorption layer is an activated carbon.

15. The cabin air filtration system of claim 14, wherein the activated carbon is regenerable.

16. The cabin air filtration system of claim 14, wherein the activated carbon is selected from one or more of a carbon felt, carbon granules, and/or carbon particles.

17. The cabin air filtration system of claim 11, wherein the first layer is a fabric filter, the fabric filter arranged on an upper surface of the cabin air filtration system and configured to face outward within a cabin air intake of the automobile.

18. The cabin air filtration system of claim 17, wherein the fabric filter is replaceable and detachable from the frame of the cabin air filtration system.

19. A method for regenerating a cabin air filtration system, the method comprising:
placing a renewable sorption layer within a frame in an oven, the renewable sorption layer configured to filter air from one or more of outside of an automobile and inside the automobile;
creating a vacuum within the oven; and
heating a source of water within the oven to perform a steam regeneration treatment on the renewable sorption layer.

20. The method of claim 19, wherein the renewable sorption layer is an activated carbon.
